(19) United States
(12) Patent Application Publication
(10) Pub. No.: US 2014/0379994 A1
(43) Pub. Date: Dec. 25, 2014

(54) DATA TRANSFER DEVICE, DATA TRANSFER METHOD, AND COMPUTER DEVICE

(71) Applicant: NEC CORPORATION, Tokyo (JP)

(72) Inventors: Takashi YOSHIKAWA, Tokyo (JP); Jun Suzuki, Tokyo (JP); Youichi Hidaka, Tokyo (JP); Junichi Higuchi, Tokyo (JP); Atsushi Iwata, Tokyo (JP)

(73) Assignee: NEC CORPORATION, Tokyo (JP)

(21) Appl. No.: 14/477,970

(22) Filed: Sep. 5, 2014

Related U.S. Application Data
(62) Division of application No. 11/928,997, filed on Oct. 30, 2007, now abandoned.

(30) Foreign Application Priority Data
Oct. 31, 2006 (JP) 2006-296360

(51) Int. Cl. G06F 12/08

(52) U.S. Cl. CPC G06F 12/0833; G06F 2212/602
USPC 711/135

(57) ABSTRACT

A local-memory side data transfer unit increments the number of addresses, reads out data from a local memory, and stores the data into a cache memory of a remote-memory side data transfer unit. For preventing data mismatching with the local memory from being stored into the cache memory, a cache clearing operation is executed in units of an elapse of a round trip time period for data transfer between the local memory and the remote memory. Alternatively, the cache clearing operation is executed upon receipt of a signal notifying data transfer of data stored at a specified address.

This application is a divisional of U.S. application Ser. No. 11/928,997, filed on Oct. 30, 2007, which is based upon and claims the benefit of priority from Japanese patent application No. 2006-296360, filed on Oct. 31, 2006, the disclosure of which is incorporated herein in its entirely by reference.

### BACKGROUND OF THE INVENTION

1. Field of the Invention

The present invention relates to a data transfer device, a data transfer method, and a computer system. More specifically, the invention relates to a data transfer device between a local memory and a remote memory, a data transfer method, and a computer system.

2. Description of the Related Art

A data transfer device between a local memory and a remote memory can execute data transfer without using or involving a central processing unit (CPU) to the local memory and the remote memory, for example in a computer system. The local memory exists on the side of a main memory, and the remote memory exists either on the side of an input/output device (I/O device) such as a hard disk or network interface card, or on the side of another computer. Such a communication or data transfer method is called a “direct memory access (DMA) data transfer or communication method”; and particularly, the method carried out between computers is called a “remote DMA (RDMA) data transfer or communication method” (refer to JP-A 2005-038218, for example).

In this case, caching and prefetching are used in order to increase the data transfer efficiency rate by reducing a time period necessary for data reading and data transfer between the computer and the I/O module. In caching, data once read out is stored in a cache memory, and when a read access is requested, data are not read from the local memory, but read from the cache memory in response to an “ACK” In this case, the number of hits increases when data to be read out exists in the cache memory, and hence the transfer performance is improved. If a largest cache memory is provided and tuning is performed to reduce cache clearing, a practical transfer performance is improved. For the purpose of the improvement of the transfer performance, a hit rate of cached data is monitored and data clearing is carried out sequentially from data having a low hit rate, thereby causing disadvantages requiring enlargement in the sizes of circuits, such as a hit rate monitoring counter, for example.

In addition, a caching method using prefetching is used. In the caching method, not only data once read out are stored, but also new data are stored in the cache memory by prefetching. In this method, data to be read out later is predicted by an appropriate technique, and then the data are preliminarily transferred to be stored into the cache memory. When an “ACK” (acknowledgement) is received after caching, and hits data and an address thereof stored in the cache, the data can be transferred therefrom to the remote memory. Consequently, a time period for the process of read-accessing the data and transfer of the data to the cache memory can be reduced.

In a technique related to prefetching, such as disclosed in JP-A-2006-099358, when DMA is started, it is checked whether data are specified for continuous transfer. When the data are specified for continuous transfer, the data are preliminarily read (pre-read). As an alternative technique, such as disclosed in JP-A-2005-038218, a command stored in a DMA queue is preliminarily read (pre-read) to thereby pre-read addresses thereof. The respective techniques are dependent on functions of the I/O module as: “store data in a queue buffer,” “checks the contents of the data,” and then “determines the type of prefetching (prefetch operation)”. Consequently, prefetching has to be executed through analysis of operation by device driver software for controlling I/O module. Further, when prefetching data and clearing data have to be determined by checking the context of data, device driver software is necessary for checking the context.

Further, as another technique related to the present invention, JP-A-2006-072832 describes that a image processing system has a DRAM primarily storing image data, a DRAM control part performing read/write control of the DRAM; image processing parts performing prescribed image processing to the image data, and a cache system disposed between the DRAM control part and the image processing parts. The cache system performs preliminary reading of a read address to the DRAM, and write-back operation which data are written later in a lump.

Further, JP-A-2001-175527 (paragraph No. (0033), etc.) describes that cache data are stored in a data cache portion of a network server, and the cached data are invalidated after a specified holding period of time. Further, JP-A-01-305430 describes that a command-fetching cache memory, which is one of two cache memories respectively provided to store copies of, for example, commands and data on a main memory, deletes data in accordance with a cancellation request. Further, JP-A-09-293044 (paragraph Nos. (0022) and (0023)) describes that data are pre-read by DMA and are then stored into a buffer.

### SUMMARY OF THE INVENTION

An exemplary object of the present invention is to provide a data transfer device not dependent on a respective I/O device and CPU/OS.

Another exemplary object of the present invention is to provide a data transfer device having a small circuit size.

According to an exemplary first aspect of the present invention, there is provided a data transfer device to be disposed between a local memory and a remote memory, which the device includes a data prefetch portion for prefetching data stored in the local memory, a cache memory for caching the prefetched data, a data transfer portion for transferring the cached data to the remote memory while controlling handshaking with the remote memory; and a cache clearing portion for erasing the cached data cached into the cache memory under a predetermined condition.

According to an exemplary second aspect of the present invention, there is provided a data transfer method for a data transfer device to be disposed between a local memory and a remote memory, which the method includes prefetching data stored in the local memory, caching the prefetched data into a cache memory, transferring the data cashed into the remote memory to the remote memory while controlling handshaking with the remote memory, and erasing the data cached into the cache memory under a predetermined condition.

According to an exemplary third aspect of the present invention, there is provided a computer system including a computer including a central processing unit (CPU) and a local memory, an input/output module (I/O module) including a remote memory and an I/O device and coupled to the computer, and a DMA controller provided in the computer or in the I/O module or between the computer and the I/O module, wherein the computer further includes a data prefetch portion for prefetching data stored in the local memory, and the I/O module further includes a cache memory for caching the prefetched data, a data transfer portion for transferring the data cashed into the remote memory while controlling handshaking with the remote memory, and a cache clearing portion for erasing the data cached under a predetermined condition after caching.

### BRIEF DESCRIPTION OF THE DRAWINGS

FIGS. 1A and 1B is a block diagram of a first embodiment of a data transfer device in accordance with the present invention;

FIG. 2 is a block diagram of a computer system using the data transfer device shown in FIGS. 1A and 1B:

FIG. 3 is a block diagram of an explanatory block diagram of operation of the computer system shown in FIG. 2;

FIG. 4 is a block diagram of an explanatory block diagram of operation of the computer system shown in FIG. 2;

FIG. 5 is a block diagram of an explanatory block diagram of operation of the computer system shown in FIG. 2;

FIG. 6 is a block diagram of an explanatory block diagram of operation of the computer system shown in FIG. 2;

FIG. 7 is a block diagram illustrative of disadvantages being solved by the first embodiment of a data transfer device in accordance with the present invention;

FIGS. 8A and 8B is a block diagram showing in detail the interior of the configuration shown in FIGS. 1A and 1B; and

FIGS. 9A and 9B is a block diagram of a second embodiment of a data transfer device in accordance with the present invention.

### DETAILED DESCRIPTION OF THE EXEMPLARY EMBODIMENTS

Exemplary embodiments of the present invention will be described in detail hereinbelow with reference to the drawings. The respective embodiments will be described with reference to a case in which data transfer is executed between a local memory and a remote memory without using a CPU in a computer system. The I/O device is, for example, a hard disk or network interface card. In this case, the local memory exists on the side of a main memory, and the remote memory exists on the side of in an I/O device such as a hard disk or network interface card. However, the exemplary embodiments can be adapted to a configuration in which data transfer is executed between a local memory existing in a main memory of one computer and a remote memory existing in another computer without using a CPU.

### First Embodiment

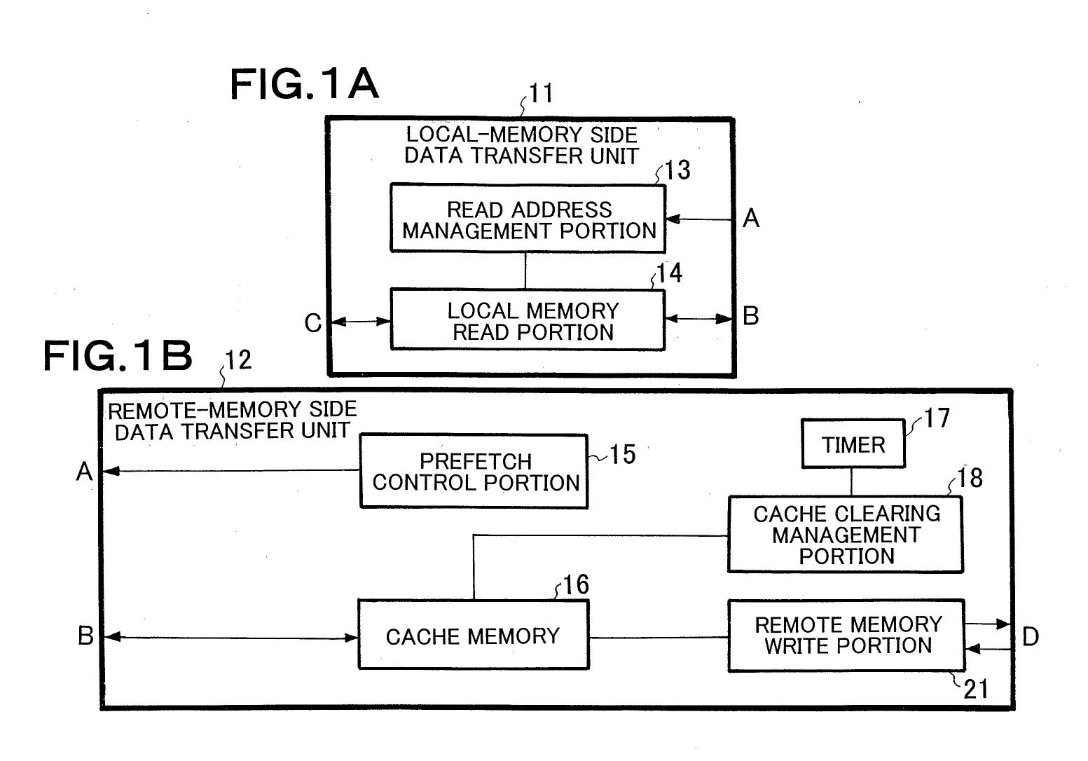

With reference to FIGS. 1A and 1B, a data transfer device of the present embodiment includes a local-memory side data transfer unit 11 and a remote-memory side data transfer unit 12. The respective configurations of the data transfer units 11 and 12 will be described in detail later.

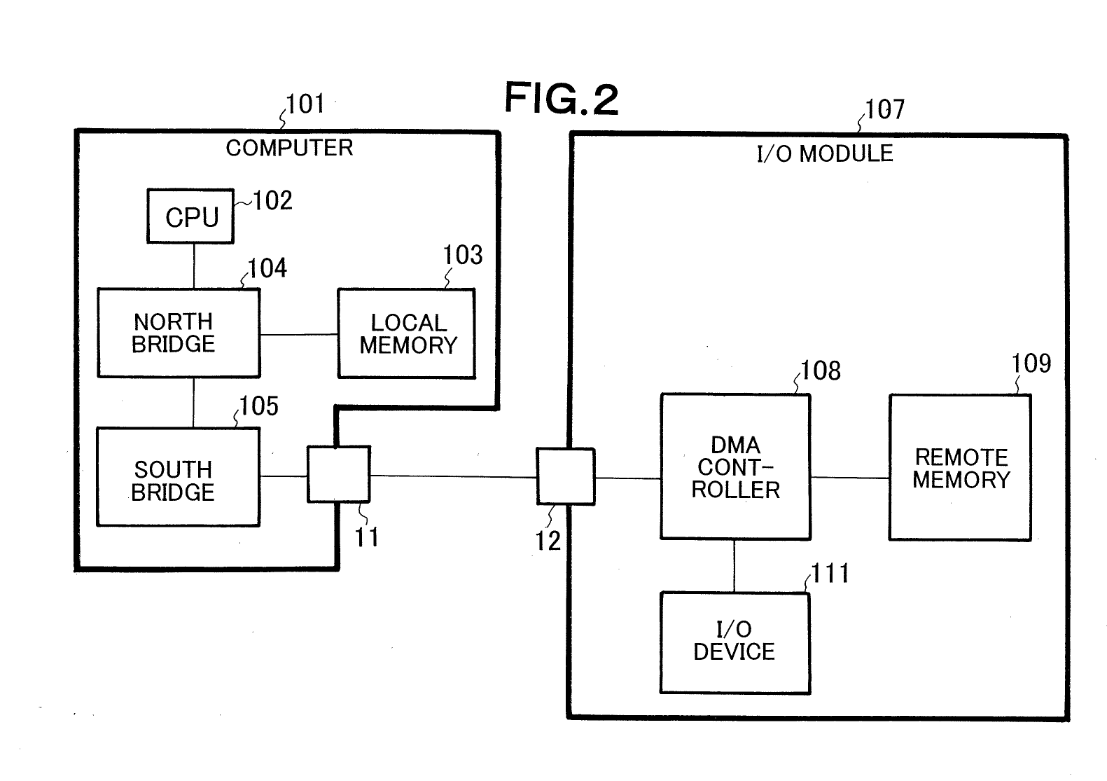

First, a total operation of a computer system involve the data transfer device will be described here with reference to FIGS. 2 to 6. In the present embodiment, when a distance or network device causing some amount of delay exists between a local memory 103 and a remote memory 109, an operation is executed to compensate for a deterioration of the transfer efficiency due to the delay. The present embodiment is described with reference to a case in which a DMA controller 108 exists on the side of an input/output module (I/O module) 107. Similarly as techniques of the related art, in the present embodiment, while awaiting termination of exchange of data for handshakes, such as “ACK” (acknowledgment) and “Completion” notifications between a local memory 103 and a remote memory 109, data are preliminarily transferred from a memory on other side to a cache memory by using an operation generally called “prefetching” or “prefetch operation.” Thereby, the delay is reduced, consequently making it possible to increase the data transfer efficiency.

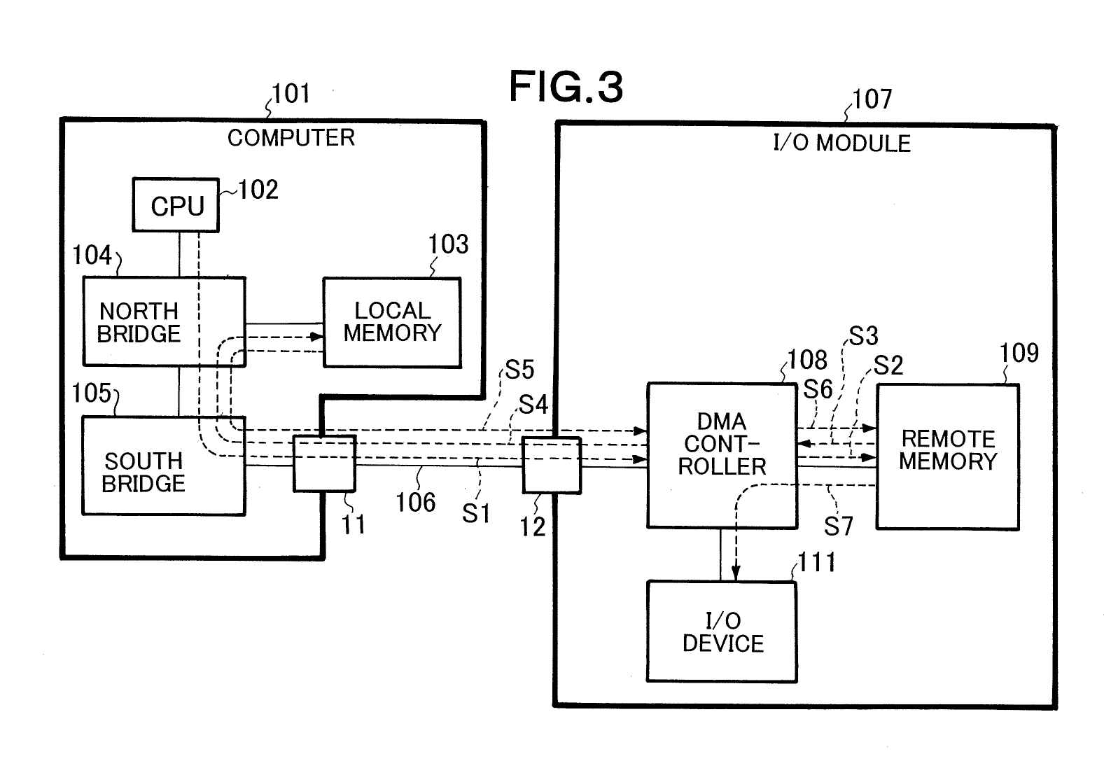

Operation not involving prefetching will first be described herein with reference to FIG. 3. Data existing (stored) in the local memory 103 is DMA-transferred from a computer 101 to the I/O module 107 via a north bridge 104 (memory control chip set), a south bridge 105 (I/O controlling chip set), and a PCI bus 106 (PCI: peripheral component interconnect). A flow (steps S1 to S7) in this case will be sequentially described herebelow. In addition, a case will be described herebelow in which data existing (stored) in the local memory 103 of the computer 101 is written into the remote memory 109 of the I/O module 107.

First, activation of a WRITE operation is directed (requested) from an OS (operating system) running on the CPU 102 to a DMA controller 108, and an address in the local memory 103 for write-desired data is notified to the DMA controller 108 (step S1). In response, the DMA controller 108 checks (verifies) whether write preparatory conditions are ready, such as availability of a write area for writing the data into the remote memory 109 (step S2). If the write preparatory conditions are ready, the remote memory 109 returns an “ACK” (acknowledgment) (step S3). The DMA controller 108 receives the “ACK” and then, reads data at the specified address of the local memory 103 (step S4). After readout of the data, the data and a “Completion” (notification) indicative of a readout completion is transferred from the local memory 103 (step S5). The data and the address therefor are stored into the cache memory and are also forwarded to the remote memory 109 (step S6). Finally, the data are transferred into an I/O device 111, such as a hard disk or an interface (step S7). In practice, a series of the operations described above is executed between the local-memory side data transfer unit 11 and the remote-memory side data transfer unit 12, the two units 11 and 12 are inexistent in software at the sides of the computer 101 and the I/O module 107.

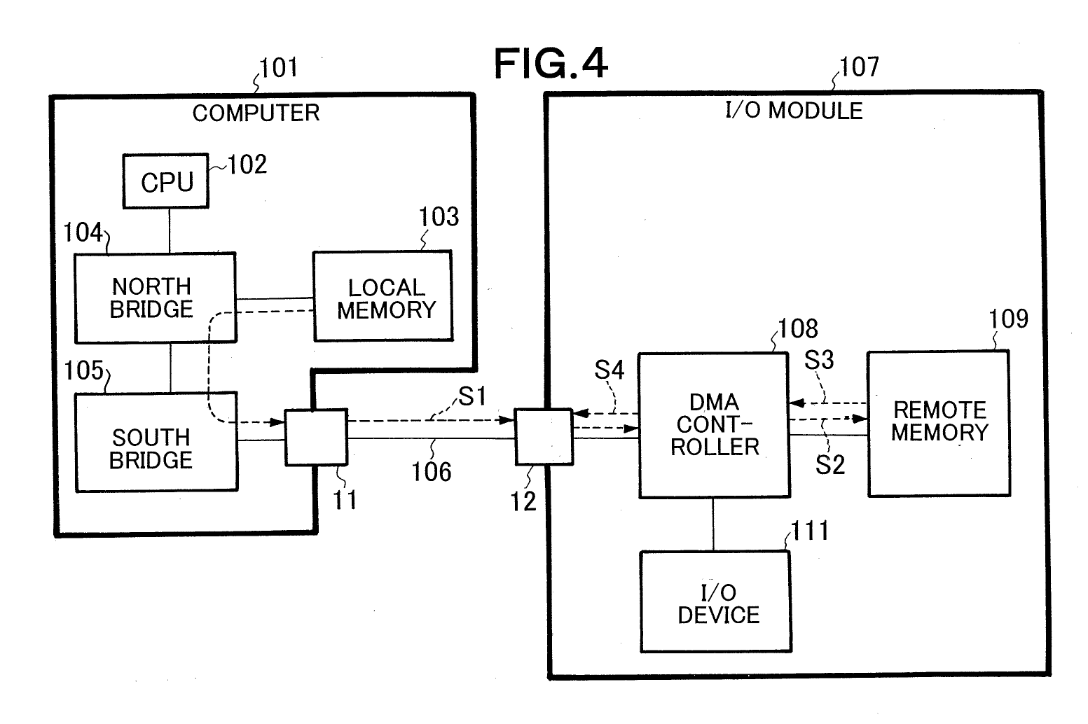

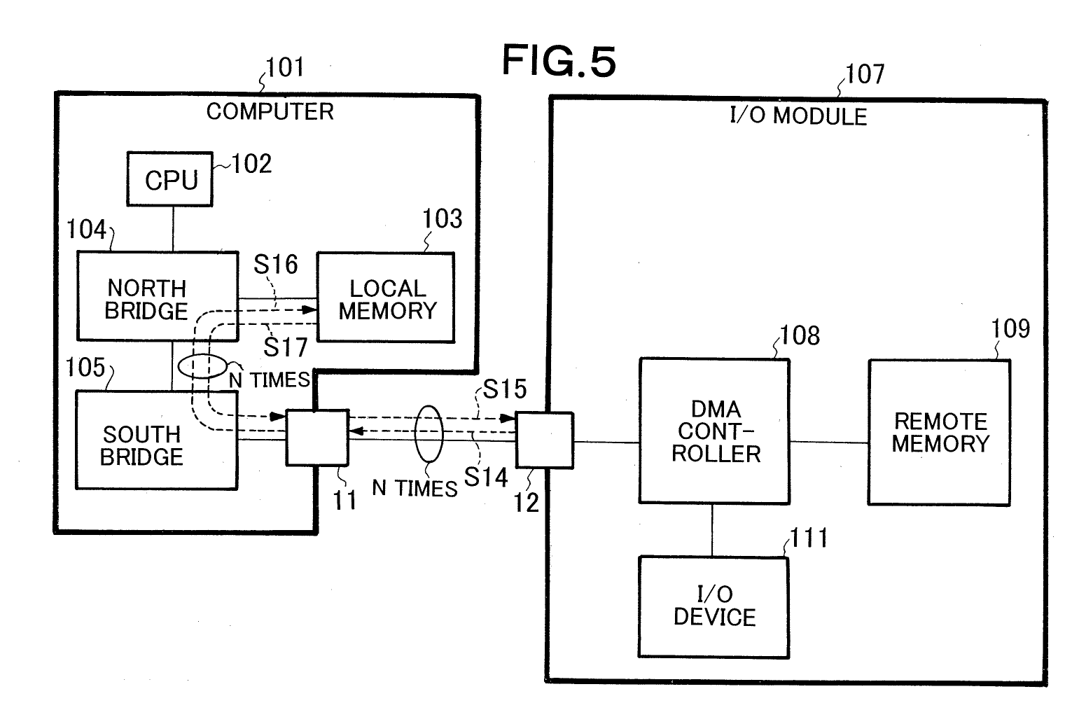

An operation flow for executing prefetching in accordance with the present embodiment will be described herebelow with reference to FIGS. 4 and 5.

First, activation of a WRITE operation is directed from the OS running on the CPU 102 to a DMA controller 108, and an address in the local memory 103 for write-desired data is notified to the DMA controller 108 (step S1). In response, the DMA controller 108 checks whether write preparatory conditions are ready, such as availability of a write area for writing the data into the remote memory 109 (step S2). If the write preparatory conditions are ready, the remote memory 109 returns an “ACK” (step S3). The DMA controller 108 receives the “ACK” and then, reads data at the specified address of the local memory 103 (step S4). In these operations, the local-memory side data transfer unit 11 and the remote-memory side data transfer unit 12 pass input data to the other side.

When the remote-memory side data transfer unit 12 receives a READ command from the DMA controller 108, the remote-memory side data transfer unit 12 transfers the command to the local memory 103, and forward also a specification to the local-memory side data transfer unit 11 to read also a memory area of N bits subsequent to a READ address of the command (step S14). The local-memory side data transfer unit 11 receives the specification and then, sequentially reads from the local memory 103 data in a range from data stored at a specified address to data stored at an Nth address (steps S16 and S17). In this case, the local-memory side data transfer unit 11 autonomously executes a handshake process relevant to DMA to the local-memory side south bridge 105 (I/O controlling chip set). More specifically, the unit 11 autonomously specifies the data in the range to the Nth data and the N times of issuances of the READ command. Concurrently, the data transfer unit 11 transfers read-out data to the remote-memory side data transfer unit 12 (step S15).

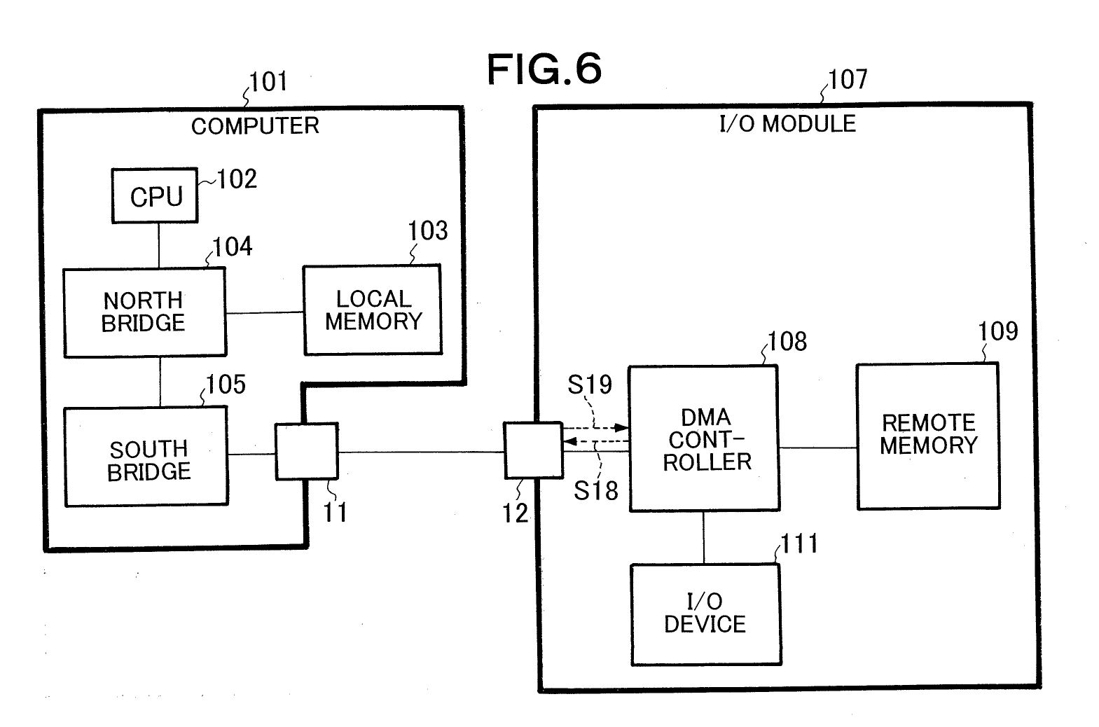

The remote-memory side data transfer unit 12 receives the data and then, stores the data into the internal cache memory. With reference to FIG. 6, when a READ command of an address hitting on the stored data is issued from the DMA controller 108 (step S18), the remote-memory side data transfer unit 12 returns corresponding data stored in the cache memory of its own, instead of reading data from the local memory 103 (step S19). Thereby, the amount of delay in the transfer of the READ command from the remote-memory side data transfer unit 12 to the I/O controlling chip set 105 and the amount of delay in the transfer of the data from the local memory 103 to the remote-memory side data transfer unit 12 are reduced.

In addition, it is sought to consider situations in which the memory of data in the local memory 103 is rewritten or overwritten (“overwritten,” hereinafter) after storage of the data into the cache memory, so that matching therebetween cannot be attained. Generally speaking, during activation of DMA transfer processing, the OS, which runs on the I/O controlling chip set 105 or CPU 102, provides locking of the memory until receipt of a Completion command notifying completion of the processing from the DMA controller 108 so that DMA transferred data are not permitted to be changed by overwriting. As such, a case where a mismatch with the cache can occur is a case where, when DMA access is once terminated, a READ command (a READ request) is issued for access to memory at the same address where data will be cached by coincidence in the subsequent processing.

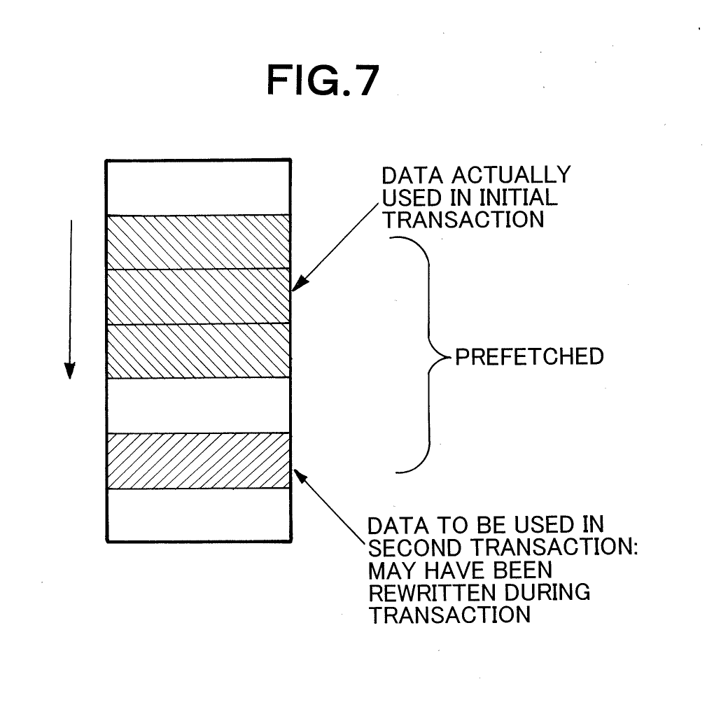

FIG. 7 depicts an example of a case such as described above. In the example case, it is assumed that data for up to five addresses ahead are cached in a first transaction. It is further assumed that, despite the above, the data actually required from the DMA controller 108 is for up to three addresses, DMA access is once terminated, and a “Completion” (notification) is issued. Further, it is assumed that the lock of the local memory 103 is unlocked in response to the “Completion” (notification) thus issued, and memory for the corresponding area is overwritten by other process. In this case, after the overwriting, when the processing attempts to read data stored in an area of a cached address of the local memory 103 from the side of the I/O module, the cache memory is hit, so that data stored before the overwriting is read out.

Operation for precluding such a mismatch with the cache will be described herebelow in association with the configurations of the local-memory side data transfer unit 11 and the remote-memory side data transfer unit 12, with reference to FIGS. 1A and 1B and other relevant drawings.

The local-memory side data transfer unit 11 is configured to include a read address management portion 13 and a local memory read portion 14, and is connected to the local-side I/O controlling chip set 105 through a port C and to the remote-memory side data transfer unit 12 through ports A and B.

The remote-memory side data transfer unit 12 is connected to the local-memory side data transfer unit 11 through the ports A and B and to the DMA controller 108 through a port D. The ports A and B are functionally different from each another; however, actually, a packet passes through a same physical medium, thereby reducing the amount of hardware resources. A control drive includes blocks respectively representing a prefetch control portion 15 that controls prefetching, cache clearing management portion 18 that controls cache-clear operation, and a timer 17 that performs time output to the cache clearing management portion 18. A data drive includes a cache memory 16 that stores prefetching data, and a remote memory write portion 21.

When a DMA WRITE command is issued to the remote-side DMA controller 108 via the local-side south bridge 105 (I/O controlling chip set), the command is passed through the local-memory side data transfer unit 11 and the remote-memory side data transfer unit 12 and is thereby forwarded to the DMA controller 108 of the I/O module 107. Upon verifying that write preparatory conditions of the I/O module 107 is ready, the DMA controller 108 issues to the local memory 103 a READ command which an address is specified. In the remote-memory side data transfer unit 12, when a prefetching function is ON in the prefetch control portion 15, information of a prefetching initiation instruction and how many addresses are to be incremented for pre-reading (increment value) is sent to the local-memory side data transfer unit 11. In the local memory read portion 14 of the local-memory side data transfer unit 11, upon receipt of the information, while a normal handshaking with the local memory 103 is being executed, data are read and transferred to the remote-memory side data transfer unit 12. Normally, no read of the local memory 103 is executed before receipt of a new READ command. However, in the present embodiment, a number of reads are continually executed corresponding to the specified number (increment value). The read address specification is provided by the read address management portion 13. Data having been read out is transferred by necessity to the remote-memory side data transfer unit 12.

In the remote-memory side data transfer unit 12, while handshaking with the remote memory side is being executed, data received at the port B is transferred from the remote memory write portion 21 to the remote memory 109. On the other hand, in the event of prefetched data, the data are stored into the cache memory 16 for storing prefetched data. When a new READ request is received from the remote-memory side DMA controller 108 and has hit the cache, the READ request is not forwarded to the local memory side, but data in the cache memory 16 is returned to the DMA controller 108.

As described above, the mismatch can occur between cached data and data existing on the local memory side after the DMA WRITE completion notification is received in the OS from the remote memory side DMA controller 108 via the local-memory side chip sets, and the lock of the local memory 103 is responsively unlocked. More specifically, it takes a time period for one-way transfer of data from the remote side to the local side until the lock of the local memory 103 is unlocked. Thereafter, it further takes a time period for one-way transfer of data from the local memory side to the remote memory side until a next transaction is issued from the local memory side, the DMA controller 108 is activated, a READ command for reading a corresponding memory address area is issued, and the command is received in the remote-memory side data transfer unit 12. Consequently, when measuring the time period by using the timer 17 from a time point at which data has immediate-previously forwarded to the remote-memory side DMA controller 108 from the cache memory, it takes at least a time period longer than a round trip time (RTT) necessary for data transfer between the local memory 103 and the remote memory 109.

When, by using the above-described time period, the time period is measured by the timer 17, and all the cached data (prefetched data) is cleared by the cache clearing management portion 18, it is guaranteed that no mismatch occurs between data existing in the caching and data stored in the local-memory.

More specifically, in the case that the prefetched data are stored into the cache memory 16, when a new READ request has arrived from the DMA controller 108 and has hit the cache, the READ request is not forwarded to the local memory side, but data existing in the cache memory 16 is returned to the DMA controller 108. When an elapse of the time period RTT from a time point that the data existing in the cache memory 16 is returned to the DMA controller 108 has been detected by the timer 17, prefetched data existing in the cache memory are all cleared by the cache clearing management portion 18.

In the example shown in FIG. 3, while the DMA controller 108 exists on the I/O module side, it either can exist on the computer 101 side or can exist as a bridge between the computer 101 and the I/O module 107.

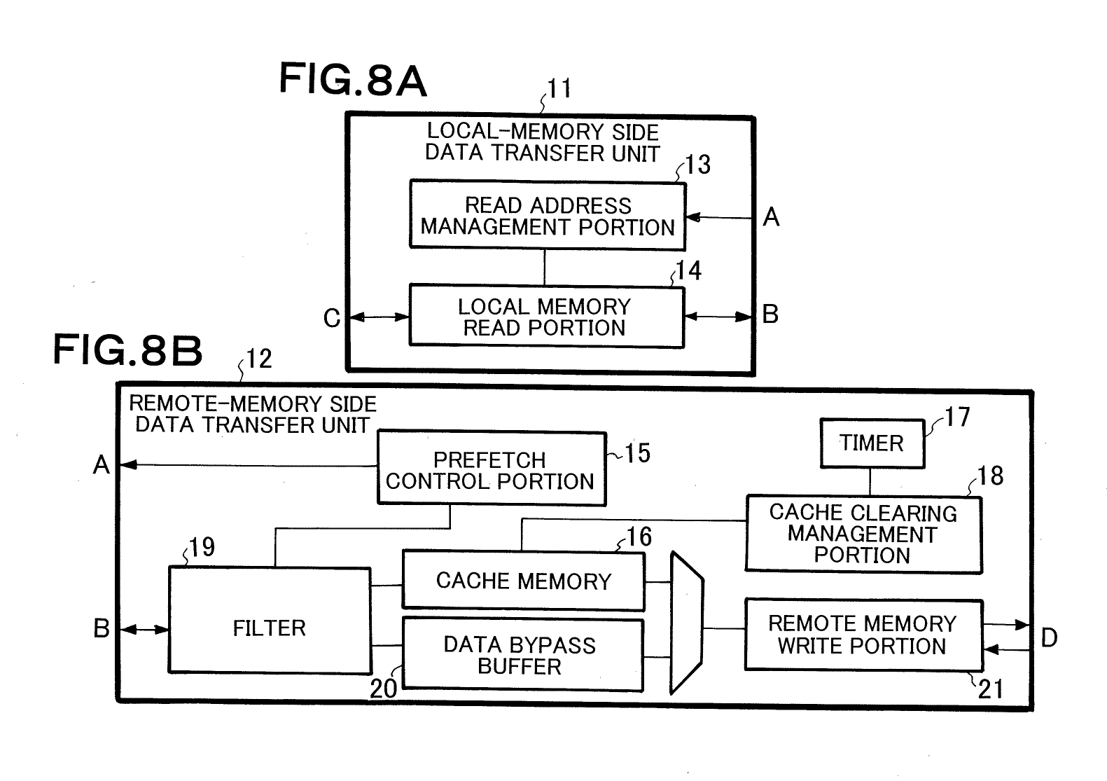

A practical embodiment will be described herebelow with reference to FIGS. 8A and 8B.

A local-memory side data transfer unit 11 is configured to include a read address management portion 13 and a local memory read portion 14, and is connected to a local-side south bridge 105 (I/O controlling chip set) through a port C and to a remote-memory side data transfer unit 12 through ports A and B.

The remote-memory side data transfer unit 12 is connected to the local-memory side data transfer unit 11 through the ports A and B and to a DMA controller 108 through a port D. The ports A and B are functionally different from each another; however, actually, a packet passes through a same physical medium, thereby reducing the amount of hardware resources. A control drive includes blocks respectively representing a prefetch control portion 15 that controls prefetching, cache clearing management portion 18 that controls cache-clear operation, and a timer 17 that performs time output to the cache clearing management portion 18. A data drive includes a filter 19 (selector) that separates data into prefetched data and other data, a data bypass buffer 20 through which pass-through data passes, a cache memory 16 that stores prefetching data, and a remote memory write portion 21.

When a DMA WRITE command is issued to the remote-side DMA controller 108 via the local-side south bridge 105 (I/O controlling chip set), the command is passed through the local-memory side data transfer unit 11 and the remote-memory side data transfer unit 12 and is thereby forwarded to the DMA controller 108 of the I/O module 107. Upon verifying that write preparatory conditions of the I/O module 107 is ready, the DMA controller 108 issues to the local memory 103 a READ command which an address is specified. In the remote-memory side data transfer unit 12, when a prefetching function is ON in the prefetch control portion 15, information of a prefetching initiation instruction and how many addresses are to be incremented for pre-reading is sent to the local-memory side data transfer unit 11. In the local-memory side data transfer unit 11, upon receipt of the information, while a normal handshaking with the local memory 103 is being executed, data are read and transferred to the remote-memory side data transfer unit 12. Normally, no read of the local memory 103 is executed before receipt of a new READ command. However, in the present embodiment, a number of reads are continually executed corresponding to the specified number. The read address specification is provided by the read address management portion 13. Data having been read out is transferred by necessity to the remote-memory side data transfer unit 12.

In the remote-memory side data transfer unit 12, a verification is made whether the data received at the port B is prefetched data. When the data are not prefetched data, the data are passed through the data bypass buffer 20 and are transferred to the remote memory 109 from the remote memory write portion 21, while handshaking with the remote memory side. On the other hand, in the event of prefetched data, the data are stored into the cache memory 16 for storing prefetched data. When a new READ request is received from the remote-memory side DMA controller 108 and has hit the cache memory 16, the READ request is not forwarded to the local memory side, but data in the cache memory 16 is returned to the DMA controller 108.

As described above, the mismatch can occur between cached data and data existing on the local memory side after the DMA WRITE completion notification is received in the OS from the remote memory side DMA controller 108 via the local-memory side chip sets, and the lock of the local memory 103 is responsively unlocked. More specifically, it takes a time period for one-way transfer of data from the remote side to the local side until the lock of the local memory 103 is unlocked. Thereafter, it further takes a time period for one-way transfer of data from the local memory side to the remote memory side until a next transaction is issued from the local memory side, the DMA controller 108 is activated, a READ command for reading a corresponding memory address area is issued, and the command is received in the remote-memory side data transfer unit 12. Consequently, when measuring the time period by using the timer 17 from a time point at which data has immediate-previously forwarded to the remote-memory side DMA controller 108 from the cache memory, it takes at least a time period longer than a round trip time (RTT) necessary for data transfer between the local memory 103 and the remote memory 109.

When, by using the above-described time period, the time period is measured by the timer 17, and cached data (prefetched data) is cleared by the cache clearing management portion 18, it is guaranteed that no mismatch occurs between data existing in the caching and data stored in the local-memory side data.

### Second Embodiment

A second embodiment will be described in detail with reference to the drawings.

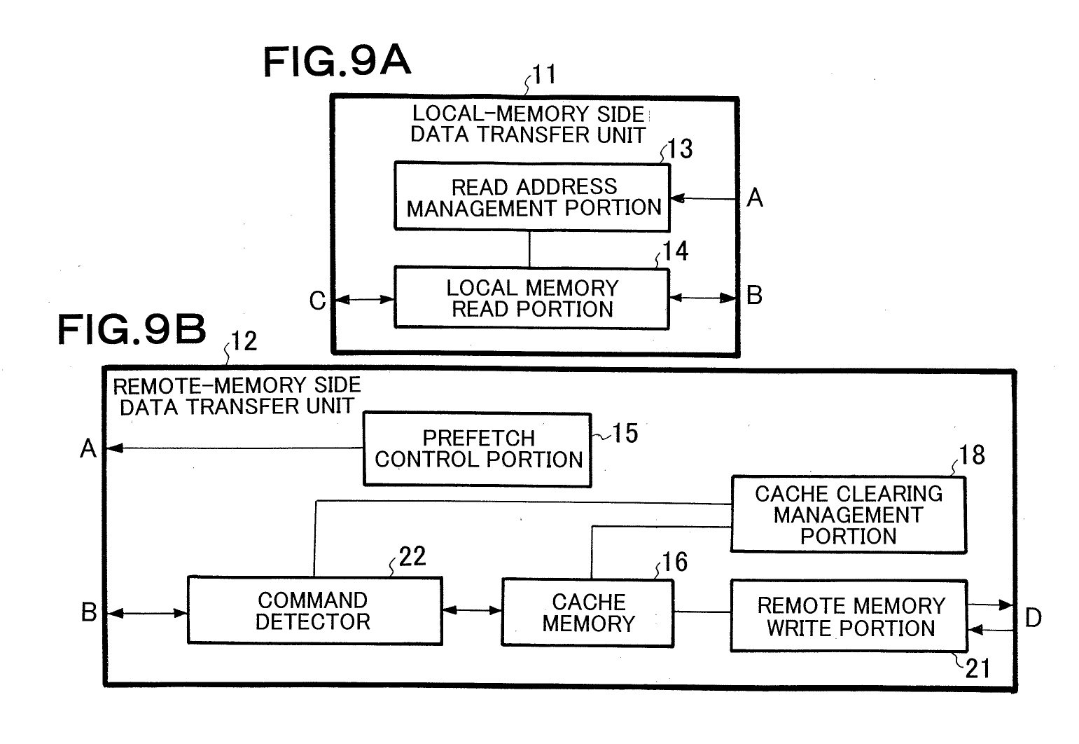

With reference to FIGS. 9A and 9B, a command detector 22 has a filter function that detects only the WRITE command in data forwarded from the local memory side. A subsequent DMA transfer is not executed unless immediately previous DMA transfer processing involving prefetching is completed and a completion notification thereof is issued from the DMA controller 108, and the south bridge 105 (I/O controlling chip set) and the OS have completed the DMA process. Data possibly having the mismatch may be fetched and forwarded from the cache memory 16 to the remote memory 109 in a case where READ is activated from the I/O side, that is, the case where the WRITE command is activated from the CPU (local memory side). As such, when the cache is cleared at a time point when the WRITE command incoming from the CPU (local memory side) is detected, an instance does not occur in which data possibly having mismatch is fetched from the cache. More specifically, an instance where data having the risk of mismatch with the cache is prevented from being read on the remote side is in the following manner. The command detector 22 detects a WRITE command incoming from the CPU at the port B; then, in accordance with a detection signal of the command detector 22, the cache clearing management portion 18 accesses the cache memory 16 and clears all prefetched data existing in the cache memory 16.

Thus, the present embodiment has been described with reference to the case where data existing in the local memory 103 of the computer 101 is written into the remote memory 109 of the I/O module 107. In this case, prefetched data are cleared when the WRITE command from the CPU (local memory side) is detected by the command detector 22 after prefetched data are stored into the cache memory 16. However, the process is not limited thereto. The process may be such that the prefetched data are cleared when a COPY command from the CPU (local memory side) has been detected by the command detector 22. Alternatively, the process may be such that the prefetched data are cleared when a READ command from the CPU (local memory side) has been detected by the command detector 22. Thus, the prefetched data can be cleared when any one of the WRITE, COPY, and READ commands has been detected.

The second embodiment of the present invention has not only the advantages of the first embodiment, but also an advantage in that timer setting/resetting need not be controlled, therefore simplifying the circuitry.

The configuration may be a combination of the respective configurations of the present and the first embodiments. More specifically, the timer 17 shown in FIGS. 1A, 1B and the command detector 22 are both provided, whereby data in the cache can be cleared either upon the elapse of the time period RTT or upon the detection of the command, such as WRITE command.

Each of the data transfer devices of the exemplary embodiments described above is interposed between a local memory of a data transfer source and a remote memory of a data transfer destination. Addresses subsequent to a current read address are read out and readout data are stored in a cache memory. In this case, operations such as preliminary reading of the contents of data and a command are not executed. However, the data transfer device includes a cache clearing portion, whereby cached data are immediately discarded (erased) when conditions for physically or logically guaranteeing coherency of the data with the local memory is not satisfied. The configuration as described above is employed, and prefetching and cache clearance are implemented by easy operations.

Each of the data transfer devices of the exemplary embodiments is capable of providing various advantages including three advantages summarized below.

A first advantage is that deterioration in transfer capability can be suppressed even in a configuration in which the distance between the local memory and the remote memory is long. This advantage can be provided because data are preliminarily transferred close to the remote memory to thereby make it possible to reduce a distance-causing delay in handshaking process.

A second advantage is that there are no dependencies on the I/O device or OS. Consequently, efficiency enhancement in data transfer can be expected whatever the type of the use environment and the type of the device may be. The advantage can be provided because no operations are involved, operations related to the configuration of the respective device, such as checking of the contents of data and queues for selection of prefetch data, and operations restricting device driver operations.

A third advantage is that the circuit size is as small as can be built-in into a small integrated circuit (IC). Consequently, a small, inexpensive, and low-power consumption system can be configured. This advantage can be provided because the contents of data and queues need not be checked, so that the sizes of circuits, such as circuits for monitoring the contents, prefetching determination circuit, and buffer circuit can be small.

The exemplary embodiments described above can be adapted to, but not limited to, various types of hardware/software devices related to DMA transfer. More specifically, the exemplary embodiments can be suitably adapted to devices which the distance between local and remote memory units is long, and a long time period is necessary for data transfer therebetween.

As above, while the exemplary embodiments of the present invention have been described, it should be understood that the embodiments permit various alterations, changes, and substitutions without departing from the spirit and scope of the invention as defined in the appended claims.

What is claimed is:

1. A data transfer device to be disposed between a local memory and a remote memory, the device comprising:
a data prefetch portion configured to prefetch data stored in the local memory;
a cache memory configured to cache the prefetched data, the prefetched data being continuous data from a specified address to an address to be pre-read;
a data transfer portion configured to transfer the cached data to the remote memory while controlling handshaking with the remote memory; and
a cache clearing portion configured to measure an elapse of a time period from a start of data transfer from the cache memory to a side of the remote memory by using a timer and erasing the cached data cached into the cache memory upon the elapse of the time period, the time period being a time period necessary for a round-trip data transfer between the local memory and the remote memory.

2. A data transfer method for a data transfer device to be disposed between a local memory and a remote memory, the method comprising:
prefetching data stored in the local memory;
caching the prefetched data into a cache memory, the prefetched data being continuous data from a specified address to an address to be pre-read;
transferring the data cashed into the cache memory to the remote memory while controlling handshaking with the remote memory;
measuring, by a cache clearing portion, an elapse of a time period from a start of data transfer from the cache memory to a side of the remote memory by using a timer; and
erasing, by a cache clearing portion, the data cached into the cache memory upon the elapse of the time period, the time period being a time period necessary for a round-trip data transfer between the local memory and the remote memory.

3. A computer system, comprising:
a computer including a central processing unit (CPU) and a local memory;
an input/output module (I/O module) including a remote memory and an I/O device and coupled to the computer; and
a Direct Memory Access controller provided in the computer, in the I/O module, or between the computer and the I/O module, wherein
the computer further includes a data prefetch portion for prefetching data stored in the local memory; and
the I/O module further includes
a cache memory configured to cache the prefetched data, the prefetched data being continuous data from a specified address to an address to be pre-read,
a data transfer portion configured to transfer the data cashed into the cache memory to the remote memory while controlling handshaking with the remote memory, and
a cache clearing portion configured to measure an elapse of a time period from a start of data transfer from the cache memory to a side of the remote memory by using a timer and erasing the data cached upon the elapse of the time period, the time period being a time period necessary for a round-trip data transfer between the local memory and the remote memory.

4. The data transfer device according to claim 1, wherein the data prefetch portion includes:
a prefetch control portion configured to specify whether a prefetching function operates or not and an address for providing a range of data to be prefetched; and
a data acquiring portion configured to perform a preliminary read and acquisition from the local memory of, data specified by addresses from an address of currently reading data to the address specified by the prefetch control portion.

5. The computer system according to claim 3, wherein the data prefetch portion includes:
a prefetch control portion configured to specifying whether a prefetching function operates or not and an address for providing a range of data to be prefetched; and
a data acquiring portion configured to perform a preliminary read and acquisition from the local memory of, data specified by addresses from an address of currently reading data to the address specified by the prefetch control portion.
